(19) United States
(12) Patent Application Publication
(10) Pub. No.: US 2004/0075894 A1
(43) Pub. Date: Apr. 22, 2004

(54) Catadioptric reduction objective

(76) Inventors: David R. Shafer, Fairfield, CT (US); Alexander Epple, Aalen (DE); Wilhelm Ulrich, Aalen (DE)

Correspondence Address: M. Robert Kestenbaum, 11011 Bermuda Dunes NE, Albuquerque, NM, 87111, US

(21) Appl. No.: 10/166,332

(22) Filed: Dec. 10, 2001

(51) Int. Cl. G02B 17/00; G02B 21/00; G02B 23/00; G02B 13/06; G02B 5/08

(52) U.S. Cl. 359/365; 359/725; 359/857

(57) ABSTRACT

A catadioptric projection objective which images a pattern arranged in an object plane into an image plane, with the production of a real intermediate image, has between the object plane and the image plane a catadioptric first objective portion and a concave mirror and a ray deflecting device and behind the ray deflecting device a dioptric second objective portion. The ray deflecting device has a preferably fully reflecting first reflecting surface for the deflection of the radiation coming from the object plane to the concave mirror. Positive refractive power is arranged behind the first reflecting surface and between this and the concave mirror, in an optical neighborhood of the object plane in which the principal ray height of the outermost field point of the radiation coming from the object is greater than the marginal ray height. A projection objective which is telecentric on the object side is thereby possible, can be well corrected with moderate requirements on the coating of mirror surfaces, and can be implemented with relatively small lens dimensions.

The invention relates to a catadioptric projection objective for imaging a pattern arranged in an object plane into an image plane.

Such projection objectives are used in projection exposure apparatuses for the production of semiconductor components and other fine-structured components, in particular in wafer scanners and wafer steppers. They are used for projecting patterns from photo-masks or reticles, which hereinafter are generally designated as masks or reticles, onto an object coated with a photosensitive layer, at the highest resolution and on a reduced magnification ratio.

Here, in order to produce increasingly finer structures, it is necessary on the one hand to increase the image-side numerical aperture (NA) of the projection objective, and on the other hand to use shorter and shorter wavelengths, preferably ultraviolet light with wavelengths of less than about 260 nm.

Only a few sufficiently transparent materials are available in this wavelength region for the production of the optical components: in particular, synthetic quartz glass, and fluoride crystals such as calcium fluoride, magnesium fluoride, barium fluoride, lithium fluoride, lithium calcium aluminum fluoride, lithium strontium aluminum fluoride, or the like. Since the Abbe constants of the available materials lie relatively close together, it is difficult to provide purely refractive systems with sufficient correction of color error (chromatic aberration). This problem could be solved by the use of purely reflective systems. However, the production of such mirror systems is expensive.

Taking account of the above problems, catadioptric systems are predominantly used for projection objectives of the said kind which have the highest resolution and in which refracting and reflecting components, thus particularly lenses and mirrors, are combined.

In the use of imaging mirror surfaces, it is necessary to use ray deflecting devices if imaging free from obscuration and free from vignetting is to be attained. Systems with one or more reflecting deflecting mirrors, and also systems with physical beamsplitters, are known. Furthermore, further plane mirrors can be used for folding the optical path. These are in general only used in order to fulfill constructional space requirements, and in particular to align the object and image planes mutually parallel. These folding mirrors are optically not absolutely necessary.

Systems with a physical beamsplitter, for example in the form of a beamsplitter cube (BSC), have the advantage that axial (on-axis) systems can be implemented. Here, for example, reflecting surfaces are used which are effective polarization-selectively, acting reflectively or transmissively in dependence on the preferred direction of polarization of the incident radiation. A disadvantage of such systems is that suitable transparent materials are scarcely available in the required large volumes. Moreover, the production of optically active beamsplitter layers within the beamsplitter cubes presents considerable difficulties. This is particularly so when large angles of incidence and/or a large angular bandwidth of the incident radiation are present at the reflecting surface.

An example of a system with physical beamsplitters is shown in EP-A 0 475 020 (corresponding to U.S. Pat. No. 5,052,763). Here the mask is situated directly on a beamsplitter cube, and the intermediate image is situated behind the beamsplitter surface in the interior of the beamsplitter cube. Another example is shown in U.S. Pat. No. 5,808,805 or the appertaining Continuation Application U.S. Pat. No. 5,999,333. Here a multi-lens lens group with positive refractive power is situated between the object plane and a beamsplitter cube. The converged light beam is first deflected by the polarizing beamsplitter surface in the direction of a concave mirror, and is reflected by this back into the beamsplitter cube and through the beamsplitter surface in the direction of the following lens group with overall positive refractive power. The intermediate image is situated within the beamsplitter cube in the immediate neighborhood of the beamsplitter surface.

Disadvantages of systems with beamsplitter cubes can be partially avoided by systems with one or more deflecting mirrors in the ray deflecting device. These systems of course have in principle the disadvantage that off-axis systems, i.e., systems with an off-axis object field, are necessarily concerned.

Such a catadioptric reduction objective is described in EP-A 0 989 434 (corresponding to U.S. Ser. No. 09/364382). In this, there are arranged between the object plane and the image plane a catadioptric first objective portion with a concave mirror and a ray deflecting device, and behind this, a dioptric second objective portion. The beamsplitter device, constructed as a reflecting prism, has a first reflecting surface for the deflection of the radiation coming from the object plane to the concave mirror, and a second reflecting surface for deflecting the radiation reflected from this to the second objective portion, which contains only refractive elements. A positive lens is arranged between the object plane and the first reflecting surface; its refractive power is adjusted such that the concave mirror is situated in the region of the pupil. The catadioptric first objective portion produces a real intermediate image, which is situated at a small distance behind the second reflecting surface and at a distance in front of the first lens of the second objective portion. The intermediate image is thereby freely accessible, and can thus can be used, e.g., for the installation of an illuminated field diaphragm. Large maximum angles of incidence, particularly on the first reflecting surface, place increased requirements on the coating of the mirror, in order to ensure a largely uniform reflection of the whole incident radiation.

Another reduction objective, which has a ray deflecting device with a deflecting mirror, is described in U.S. Pat. No. 5,969,882 (corresponding to EP-A 0 869 383). In this system, the deflecting mirror is arranged so that light coming from the object plane first falls on the concave mirror of the first objective portion, before being reflected by this to the deflecting mirror of the ray deflecting device. It is reflected by this deflecting mirror to a further reflecting surface, which deflects the light toward the lens of the purely dioptric second objective portion. The elements of the first objective portion used for the production of the intermediate image are designed so that the intermediate image is situated close to the deflecting mirror of the ray deflecting device. The second objective portion serves to re-focus the intermediate image onto the image plane, which can be arranged parallel to the object plane thanks to the reflecting surface following the intermediate image.

U.S. Pat. No. 6,157,498 shows a similar construction, in which the intermediate image is situated on or near the reflecting surface of the ray deflecting device. A few lenses of the second objective portion are arranged between this surface and a deflecting mirror in the second objective portion. An aspheric surface is also arranged in the immediate neighborhood of, or at, the intermediate image. Exclusively distortion is to be corrected hereby, without other imaging errors being affected.

A projection objective with reducing catadioptric partial system and intermediate image in the neighborhood of a deflecting mirror of a ray deflecting device is shown in DE 197 26 058.

In the already mentioned U.S. Pat. No. 5,999,333, another catadioptric reduction objective with deflecting mirror is shown, in which the light coming from the object plane, after passing through a lens group with positive refractive power, first strikes the concave mirror, by which it is reflected onto the single reflecting surface of the deflecting device. The intermediate image produced by the catadioptric portion is situated close to this reflecting surface. This reflects the light to a dioptric, second objective portion which images the intermediate image onto the image plane. Both the catadioptric objective portion and the dioptric portion have a reducing lateral magnification.

A similar objective construction, in which the intermediate image produced by the catadioptric objective portion is likewise situated in the neighborhood of the single deflecting mirror of the ray deflecting device, is shown in JP-A-10-010429. The lens surface of the following dioptric objective portion which is next after the deflecting mirror is aspheric, in order to contribute particularly effectively to the correction of distortion.

Other objectives with off-axis object field, geometrical beamsplitting, a single concave mirror, and intermediate with following dioptric portion, are known from the publications U.S. Pat. No. 5,052,763, U.S. Pat. No. 5,691,802, and EP 1 079 253 A.

Systems in which the intermediate image is situated in the neighborhood of, or on, a reflecting surface make a compact construction possible. In addition, the correcting field radius of these off-axis illuminated systems can be kept small, which facilitates the correction of imaging errors.

Catadioptric systems with beamsplitters generally have a group of double-pass lenses, passed through on the light path from the object field to the concave mirror, and on the light path from the concave mirror to the image field. It is proposed in U.S. Pat. No. 5,691,802 that this lens group has positive refractive power, which is to lead to a smaller diameter of the concave mirror. A system with individual double-pass positive lenses in the neighborhood of a deflecting mirror of the ray guide is described in U.S. Pat. No. 6,157,498.

For systems with two catadioptric partial systems, the effect of reducing the size of the concave mirror is described, for example, in U.S. Pat. No. 5,323,263, at the example of the second partial system.

Other documents in which systems with two catadioptric partial systems are described show half lenses or truncated lenses at positions at which the light bundle going to the concave mirror and the light bundle reflected from the concave mirror run separately from each other and thus do not overlap. Examples of this are shown in EP 0 527 043 A, EP 0 581 585 B, and JP 8-21955. These half lenses are in general combined with correcting groups having substantially no refractive power, e.g. positive and negative lenses of the achromat type.

Double-pass lenses generally have the disadvantage that their negative effects on the light ray, particularly reflection and absorption, are introduced twice, while the advantage of the introduction of a degree of freedom for the correction of the imaging is present only once, so that a compromise has to be found between the effects on the two light ray directions.

On the other hand, processes and methods for mounting half lenses are not well developed. The mounting of half lenses is made difficult by their geometric asymmetry. This problem is further complicated by the fact that the cut-off side of the lens is not available to mounting parts, since there must be no encroachment on the adjacent light path.

Particularly in the region of microlithography at 157 nm with very high apertures of NA=0.80 and more, for example, the problem arises of high material prices and only limited availability of calcium fluoride crystal material for large lenses. Means are therefore desired which make possible a reduction of the number and size of lenses, and at the same time contribute to maintaining, or even increasing, the imaging quality.

The invention has as its object to avoid disadvantages of the state of the art. According to an aspect of the invention, a projection objective is to be provided which can be well corrected with moderate requirements on the optical coating of reflecting surfaces, and which can be constructed with optical components of moderate size. According to another aspect of the invention, the number and size of lenses is to be reduced while maintaining or improving the optical imaging performance.

In order to attain this object, the invention proposes catadioptric projection objectives with the features of the independent claims. Advantageous developments are given in the dependent claims. The wording of all the claims is made with reference to the content of the specification.

A catadioptric projection objective according to one aspect of the invention is constituted for the imaging of a pattern arranged in an object plane into an image plane, while producing a real intermediate image. Between the object plane and the image plane, it has a catadioptric first objective portion with a concave mirror and a ray. deflecting device, and behind the ray deflecting device a second objective portion, which is preferably dioptric, and thus has no imaging reflecting surfaces. The ray deflecting device has a first reflecting surface for deflecting the radiation coming from the object plane to the concave mirror. Positive refractive power is arranged in an optical neighborhood of the object plane, behind the first reflecting surface and thus between this and the concave mirror. This optical neighborhood is in particular distinguished in that the principal ray height of the image is greater than the marginal ray height.

The positive refractive power between the object plane and the concave mirror is to contribute to a pupil surface of the projection objective being situated in the region of the concave mirror, i.e., either on the concave mirror or in its vicinity. Furthermore, an object-side telecentricity of the objective is to be attained by means of positive refractive power of suitable strength in the said optical neighborhood of the objective plane, and is advantageous for avoiding defocus errors on the object side. By the arrangement of the positive refractive power behind the first reflecting surface, it is possible for the principal rays of the imaging, running telecentrically or largely parallel to the optical axis of the system, also strike the first reflecting surface parallel to the optical axis. In contrast to conventional designs in which positive refractive power is arranged between the object plane and the first reflecting surface, this leads to a marked reduction of the angular loading of the first reflecting surface. In comparison with the state of the art, smaller maximum angles of incidence and possibly also smaller angular bandwidths of the incident radiation on the first reflecting surface are made possible, in dependence on the angle of inclination between the first reflecting surface and the optical axis of the projection objective. The requirements on the angular loadability of the optical coating provided for the first reflecting surface are thereby reduced, in comparison with the state of the art, so that coating systems of relatively simple construction can be used in order to attain largely uniform reflectivity over the whole region of angle of incidence. The positive refractive power arranged behind the first reflecting surface is preferably produced by a single lens.

In preferred embodiments, the angles of incidence of the radiation striking the first reflecting surface, with an object-side numerical aperture of 0.2125, are no greater than about 68°, and even maximum angles of incidence of no more than 66° are attainable. In general, the invention makes it possible to construct objectives in which the angle of incidence on the first reflecting surface is no greater than α₀, where

$${α}_{0} = \vert arcsin ( {β}^{*} NA \vert + \frac{{α}_{HOA}}{2}$$

Here β is the imaging scale of the projection objective, NA is the image-side numerical aperture, and α_{HOA} is the angle included by a portion of the optical axis running perpendicularly to the object plane and possibly to the image plane, and a portion of the optical axis in the region of a horizontal arm bearing the concave mirror.

These relatively low maximum angles of incidence can in particular be implemented in embodiments in which the first reflecting surface is arranged obliquely of the optical axis of the projection objective at an angle of inclination deviating from 45□. The angle of inclination can, for example, be 50□ or more, in particular between 50□ and 55□.

Furthermore, the positive refractive. power arranged close behind the first reflecting surface is more strongly refractive due to a greater distance to the object plane in comparison with known designs, and thus due to greater marginal ray heights at the marginal rays of the imaging. This can be used, with unchanged constructional size in comparison with conventional designs, in order to construct with reduced diameter the optical components following the positive refractive power, in particular the optical components of a mirror group which includes the concave mirror. This furthers a material-saving construction of the catadioptric objective portion.

Preferred embodiments have the distinctive feature that the ray deflecting device has a second reflecting surface for deflecting the radiation coming from the concave mirror to the second objective portion, and that the marginal ray intermediate image is arranged in the neighborhood of the second reflecting surface. This neighborhood of the second reflecting surface can in particular be so large that the marginal ray height at the second reflecting surface is less than 20%, in particular less than 10%, of the half diameter of the concave mirror. The marginal ray intermediate image can also fall substantially on the second reflecting surface. A marginal ray intermediate image of the imaging in the immediate neighborhood of the second reflecting surface is favorable for a minimization of the étendue of the objective and thus facilitates the correction of aberrations.

Provided that the marginal ray intermediate image is not substantially situated on the second reflecting surface, it is preferred that the marginal ray intermediate image is situated in front of the second reflecting surface in the direction of light propagation. Embodiments are particularly preferred in which positive refractive power is arranged in the neighborhood of the intermediate image, in particular between the intermediate image and the second reflecting surface. In connection with the positive refractive power close behind the first reflecting surface, largely symmetrical arrangements are then possible, in which a pupil is situated in the neighborhood of the concave mirror or principal mirror. The lateral magnification PM from the object plane as far as the intermediate image can thereby be set close to 1:1, and in particular larger than 0.95. A positive refractive power behind the intermediate image in the direction of light propagation, preferably provided by a single positive lens, can oppose an excessive divergence of principal rays after the intermediate image. The diameter of the lenses of the second objective portion following the intermediate image can be kept small, which makes possible a material-saving construction of this objective.

Advantageous projection objectives are distinguished in that at least one multi-region lens is arranged in a double-pass region of the projection objective, in particular between the ray deflecting device and the concave mirror, and has a first lens region through which light passes in a first direction, and a second lens region through which light passes in a second direction, where the first lens region and the second lens do not overlap on at least one side of the lens. If the footprints of the ray paths do not overlap on at least one of the two lens sides, such a multi-region lens makes it possible to geometrically bring to a common location, two lenses which are effective independently of each other. It is also possible to make two lenses which are effective independently of each other, bodily as one lens, namely an integral multi-region lens, from one lens blank. Such a multi-region lens is to be clearly distinguished from a conventional double-pass lens, since in a multi-region lens of this kind its optical effect on the rays which pass through independently of each other can be affected by suitable independent shaping of the refractive surfaces of the lens regions independently of each other. Alternatively, at the place of a one-piece multi-region lens, a lens arrangement with at least one half lens or truncated lens can be arranged, in order to affect independently of each other the ray bundles that go past each other.

In preferred projection objectives, the positive refractive power provided immediately behind the first reflecting surface, and the positive refractive power provided before the second reflecting surface, are supplied by such a multi-region lens. Advantages in manufacturing technique can be attained when only one lens surface of the two lens surfaces of the multi-region lens (entrance side and exit side, or vice versa) has regions of different curvature. The manufacture can then be carried out such that the lens is first prefabricated in the shape of one of the two surface portions. This is preferably a spherical shape. This region then already has the designated curvature. The other surface portion then be provided, by directed after-processing, with a curvature which differs from the curvature of the starting surface. For this purpose, polishing which may be numerically controlled by a computer can be used, in particular using ion beams.

A significant widening of the design scope can then be attained when the multi-region lens has at least one lens surface which is aspheric in at least one partial region. In particular, it can be provided, for a lens surface with regions of different curvature, that at least one of these regions is aspheric. This in particular includes the possibility of differently aspherizing two or more partial regions of a lens surface. Different curvatures of the lens halves can thereby be simulated in the respective optical ray paths. It is then advantageous if two different aspherics are derived from a common spherical base shape and differ from this by different aspheric deviations.

Projection objectives of the kind described here, with off-axis object field, a catadioptric first objective portion, and a geometric beamsplitter working with at least one deflecting mirror, and also a single concave mirror, an intermediate image and a preferred refractive second objective portion, can have, situated perpendicularly to an optical axis, at least one plane in which a first ray bundle going to the concave mirror, and a second ray bundle returning from the concave mirror, go past each other without mutually overlapping. According to one aspect of the invention, at least one half lens or truncated lens is arranged in the region of this plane passed through independently in two partial regions, which refract one of the ray bundles and is not contacted by the other ray bundle, or does not extend into its ray path. This makes possible new degrees of freedom for the design of such a highly developed projection objective. Two such partial lenses can be arranged in the plane, each independently effective on a respective one of the ray bundles which go past each other. Such embodiments in which one or, if present, two half lenses are secured to a transparent, disk-shaped support, for example to a lens or to a plane-parallel plate, are favorable for mounting techniques. The securement can be, for example, by wringing, or by cementing or adhering. The transparent body of the support can be mounted along its annular edge in a substantially annular mount. The lenses arranged in the plane through which light separately passes are preferably curved, with rotational symmetry with respect to the optical axis, in this region. The system thereby remains a centered optical system; this is advantageous in relation to design and production.

It is favorable if a group of optical elements which includes the concave mirror and one or more double-pass lenses has a lateral magnification which clearly deviates from 1; in particular, this can be between 0.5 and 0.95 or between 1.05 and 1.2. The angular distributions of the two ray bundles which go past each other in the region of the half lenses or the multi-region lens are thus made to differ significantly. This has the result that even relatively similar shapes of the lens surfaces through which light passes separately have different effects on the image correction.

Since in preferred projection objectives a positive refractive power situated between object plane and concave mirror can be largely or completely arranged behind the first reflecting surface, it is possible to construct the projection objective such that no, or little, refractive power is arranged between the object plane and the first reflecting surface. In this region, for example, there can be provided only a largely plane parallel entrance plate. This can fulfill two functions. On the one hand, the interior space of the projection objective, flushed with an inert gas, for example helium, can be sealed off from the outer space, possibly flushed with another inert gas, for example nitrogen. Furthermore, due to the planar boundary surface of the objective against the surrounding medium, the imaging performance of the projection objective becomes insensitive to pressure fluctuations. A reduced contribution of the Petzval sum, and thus of the pressure dependence of the field curvature, is substantially responsible for this. The geometrical space between the entrance element and the first reflecting surface can be free from optical components, and in particular free from positive lenses, making possible a compact construction in this region.

In preferred embodiments, the first optical element is formed by a negative lens. If negative refractive power is arranged between the object plane and the first reflecting surface, the angular loading of the first reflecting surface, small in any case, can be further reduced in projection objectives according to the invention. In addition, a vignetting-free imaging is possible with even smaller expense. The entrance side of the negative lens is preferably largely plane, in order to be able to use the described advantages of the pressure stabilization.

In one embodiment, in order to attain a good monochromatic correction or a high imaging performance and low aberrations at very large numerical aperture with small use of material, one or more aspheric surfaces can be provided. A larger number of aspheric surfaces is as a rule provided, however preferably no more than seven. It is then appropriate, particularly with regard to the correction of spherical aberration and coma, if at least one aspheric surface is arranged in the region of an aperture diaphragm plane. A particularly effective correction is then obtained if for this surface the ratio of the marginal ray height at the surface to the radius of the opening of the aperture diaphragm is between about 0.8 and about 1.2. The marginal ray height is thus to be, at the aspheric surface, near the maximum marginal ray height in the aperture diaphragm region.

In order to make possible an effective correction of the distortion and other field aberrations, it is appropriate to provide at least one aspheric surface in the field neighborhood also. In a design with an intermediate image, regions near the field are situated in the neighborhood of the object plane, in the neighborhood of the image plane, and in the neighborhood of at least one intermediate image. These regions near the field are preferably distinguished in that the ratio of marginal ray height at the surface to radius of the associated system aperture diaphragm is smaller than about 0.8, preferably smaller than 0.6.

It is favorable if at least one aspheric is arranged in the field neighborhood and at least one aspheric in the neighborhood of a system aperture diaphragm. It is thereby possible to make available a sufficient correction for all mentioned imaging errors. Since the projection objectives according to the invention have at least one intermediate image, in addition to the object plane and the image plane there is present at least one further field plane, and in addition to a system aperture diaphragm there is present at least one conjugate aperture diaphragm plane, so that many degrees of freedom exist for the installation of effective aspherics.

The preceding and further features arise from the claims and also from the specification and the drawings; the individual features can be reduced to practice, respectively alone, or several in the form of sub-combinations, in an embodiment of the invention and in other fields, and can represent advantageous embodiments which can also in themselves receive patent protection.

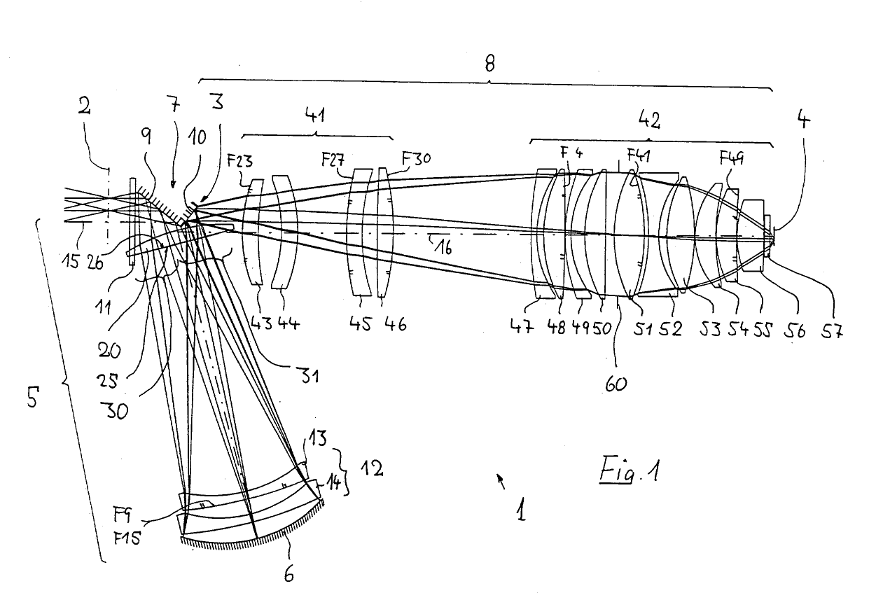

FIG. 1 shows a longitudinal sectional diagram of a first embodiment of a projection objective,

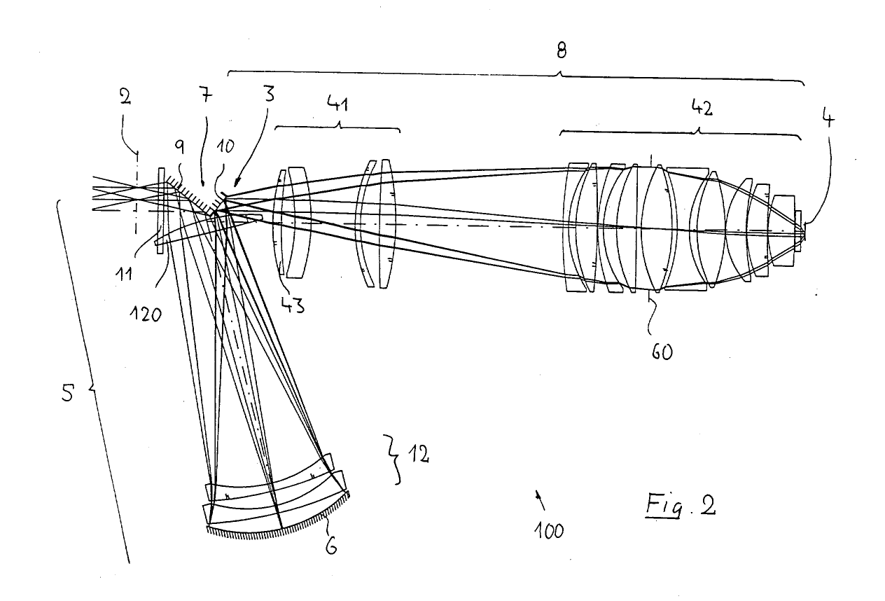

FIG. 2 shows a longitudinal sectional diagram of a second embodiment of a projection objective,

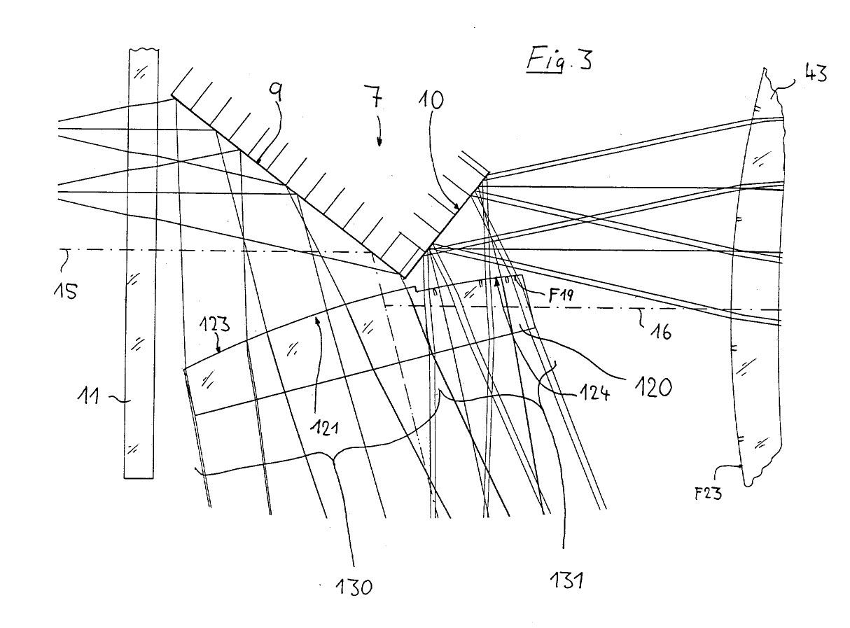

FIG. 3 shows an enlarged view of the region of the ray deflecting device in FIG. 2,

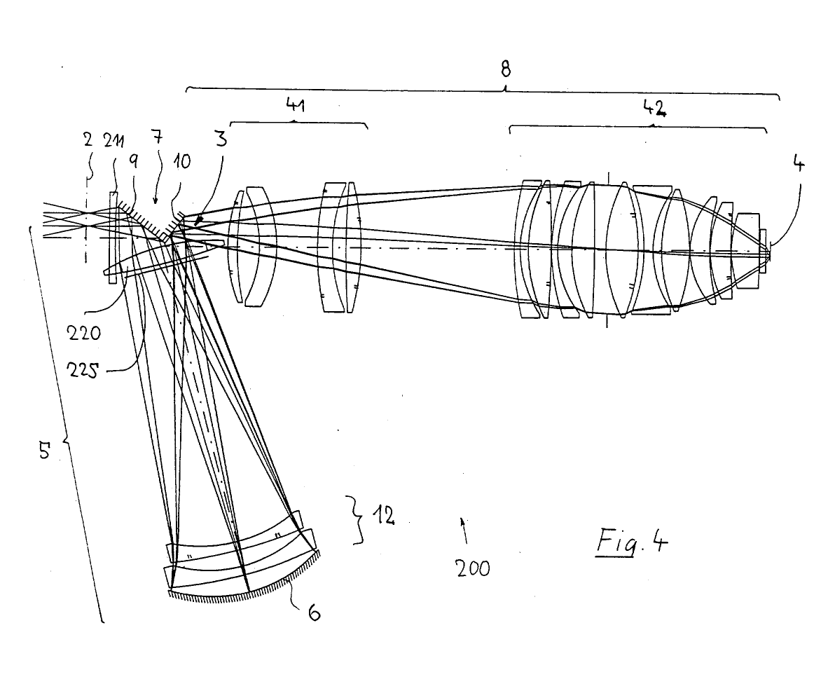

FIG. 4 shows a longitudinal sectional diagram of a third embodiment of a projection objective,

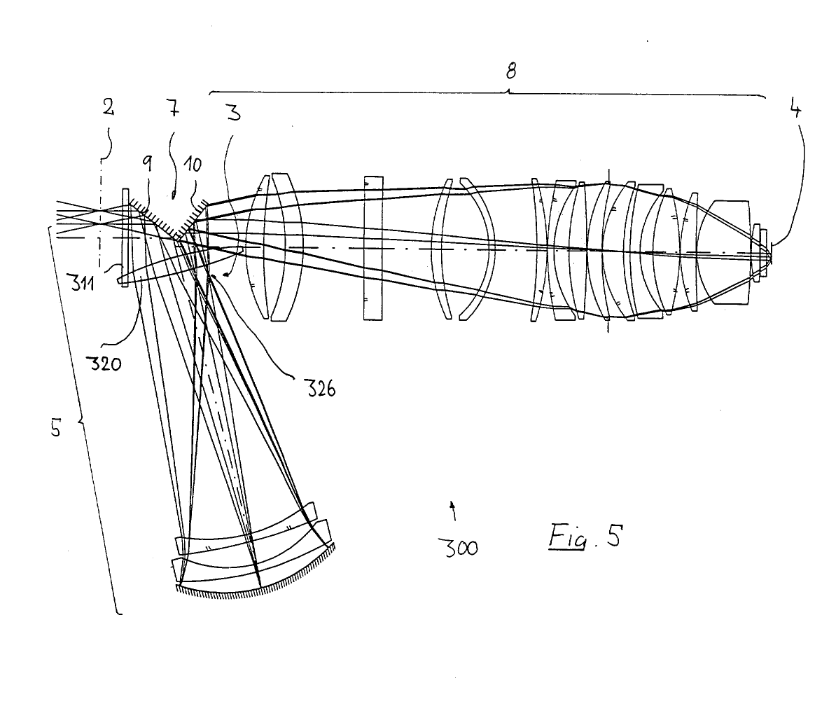

FIG. 5 shows a longitudinal sectional diagram of a fourth embodiment of a projection objective,

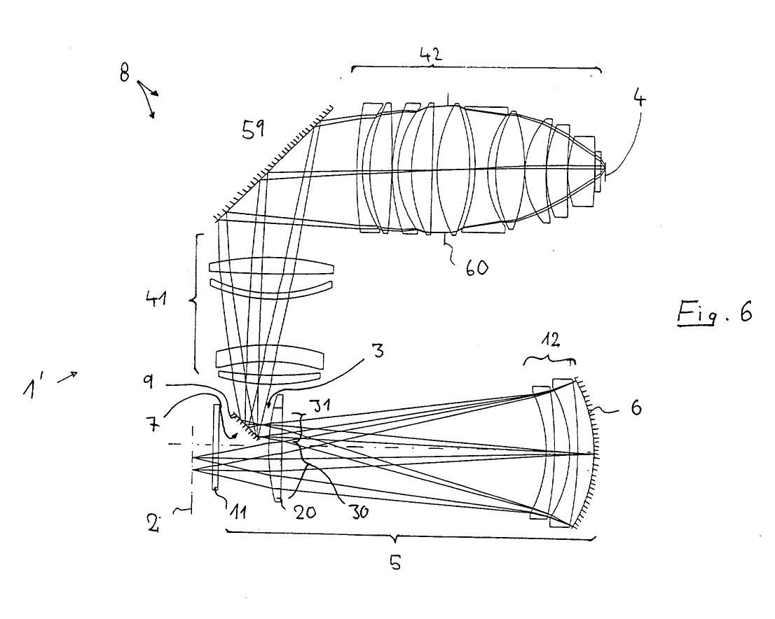

FIG. 6 shows a longitudinal sectional diagram of a fifth embodiment of a projection objective,

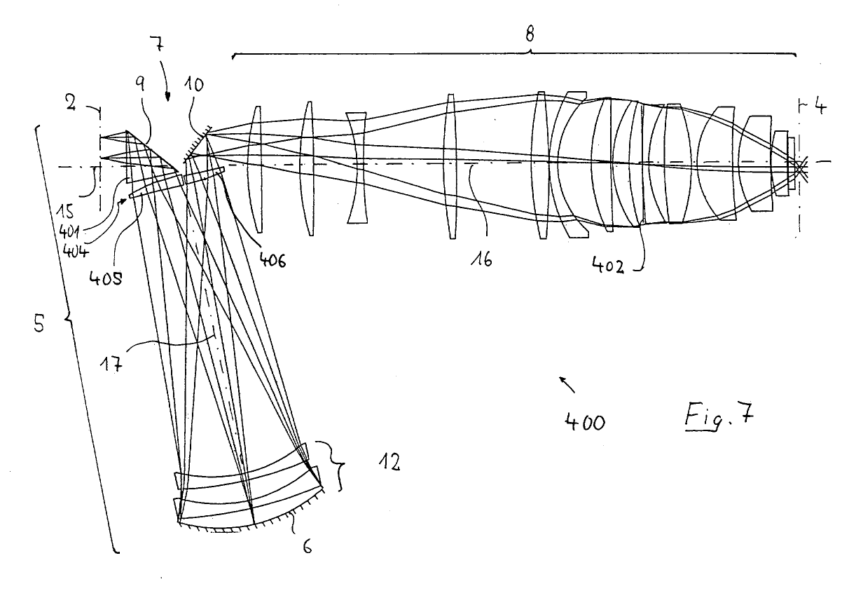

FIG. 7 shows a longitudinal sectional diagram of a sixth embodiment of a projection objective,

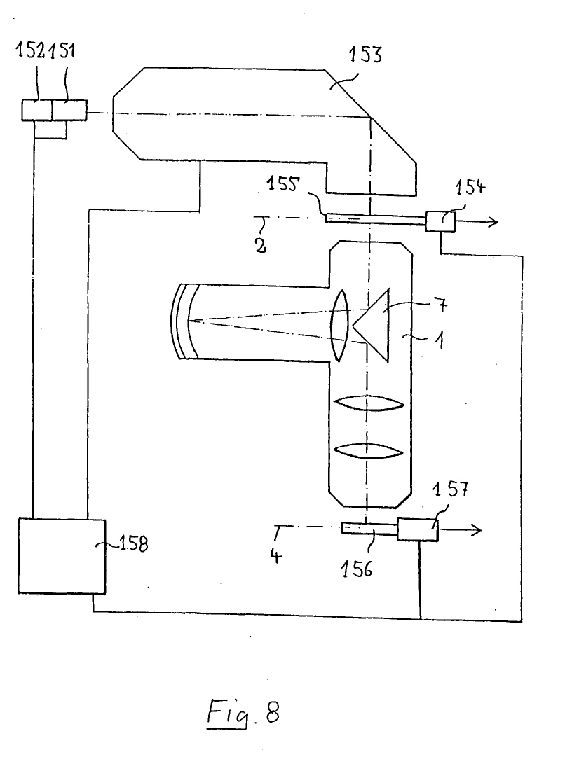

FIG. 8 shows an embodiment of a microlithographic projection exposure apparatus according to the invention.

In the following description of preferred embodiments, the concept “optical axis” denotes a straight line, or a sequence of straight line sections through the curvature midpoints of the optical components. The optical axis is folded at deflecting mirrors or other reflecting surfaces. Direction and distance are described as “image side” when they are directed toward the image plane or the substrate to be exposed which is located there; and as “object side” when in relation to the optical axis they are directed toward the object. In the examples, the object is a mask (reticle) with the pattern of an integrated circuit; however, it can also have to do with another pattern, for example, a grating. In the examples, the image is formed on a wafer provided with a photoresist layer and serving as the substrate; however, other substrates are possible, for example, elements for liquid crystal displays, or substrates for optical gratings.

Identical or mutually corresponding features of the various embodiments are hereinafter denoted by the same reference numerals for the sake of clarity.

A typical construction of a variant of a catadioptric reduction objective 1 according to the invention is shown in FIG. 1 using a first embodiment example. It serves to image a pattern, arranged in an object plane 2, of a reticle or the like, with the production of a single, real intermediate image 3 in an image plane 4 situated parallel to the object plane 2, with a reduced magnification: for example, in a 4:1 proportion. The objective 1 has, between the object plane 2 and the image plane 3, a catadioptric first objective portion 5 with a concave mirror 6 and a ray deflecting device 7, and behind the ray deflecting device a dioptric second objective portion 8 which contains exclusively refractive optical components. The ray deflecting device 7 is constituted as a mirror prism, and has a first, planar, reflecting surface 9 for the deflection of the radiation coming from the object plane 2 in the direction of the concave mirror, and also, at right angles to the first reflecting surface, a planar second reflecting surface 10 for deflection of the radiation reflected by the imaging concave mirror 6 in the direction of the second objective portion 8. While the first reflecting surface 9 is necessary for the beam deflection toward the concave mirror 6, the second reflecting surface 10 can even be omitted. Without a further deflecting mirror, the object plane and the image plane would then be substantially perpendicular to each other. A folding can also be provided within the refractive objective portion 8.

As can be seen from FIG. 1, the light from an illuminating system (not shown) on the side of the object plane 2 remote from the image enters the projection objective and first passes through the mask arranged in the object plane. The transmitted light then passes through a plane-parallel plate 11 arranged between the object plane 2 and the ray deflecting device 7, and is then deflected by the folding mirror 9 of the ray deflecting device 7 in the direction of a mirror group 12. This includes the concave mirror 6 and also two negative lenses 13, 14 placed immediately before the mirror 6 and respectively having convex surfaces toward it. The folding mirror 9 is directed at an angle to the optical axis 15 of the preceding objective portion deviating from 45°, such that the deflection takes place at a deflection angle of more than 90°, in the example about 103°-105°. The light reflected by the concave mirror 6 and returned through the double-pass negative lenses 13, 14 to the ray deflecting device 7 is deflected by the second folding mirror 10 of the ray deflecting device 7 in the direction of the dioptric second objective portion 8. The real intermediate image 3 is then produced in the neighborhood of the second folding mirror 10, before this in the direction of light propagation. The optical axis 16 of the second objective portion 8 runs parallel to the optical axis 15 of the entrance portion and thus permits a parallel arrangement between objective plane 2 and image plane 4, which makes simple scanner operation possible.

The catadioptric first objective portion 5 has as a special feature a biconvex positive lens 20 which is arranged in the immediate neighborhood of the ray deflecting device 7 and makes positive refractive power available in the immediate neighborhood of the reflecting surfaces 9, 10, both in the light path between the first reflecting surface 9 and the concave mirror 6 and also in the light path between the concave mirror 6 and the second reflecting surface 10. The double-spherical positive lens 20 in this embodiment is used as a multi-region lens, in which the first lens region 30 used on the path toward the concave mirror 6 and the second lens region 31 used on the light path toward the second mirror 10 do not overlap one another. The refractive power made available by the lens regions 30, 31 can in principle also be made available separately, by mutually independent lenses.

The lenses of the second objective portion 8 can be divided functionally into a transfer group 41 and a focusing group 42, and serve in common to image the intermediate image 3 arising before the second reflecting surface 10 into the image plane 4. The lens 43 nearest to the intermediate image is a positive mensicus lens with surfaces curved toward the object. This is followed by an oppositely curved meniscus lens 44 with weakly negative refractive power. At a greater distance, there follows a negative meniscus lens 45 with surfaces curved toward the object, followed by a biconvex positive lens 46 as the last lens of the transfer group 41. This is followed, at a greater distance, by a negative meniscus lens 47 with surfaces curved toward the object, as the first lens of the focusing group 42, and this in turn is followed by a biconvex positive lens 48, a further negative meniscus lens 49 curved toward the object, and a further biconvex positive lens 50. The freely accessible system aperture diaphragm 60 is situated in a following larger air space. This is followed by a biconvex positive lens 51, a biconcave negative lens 52, two positive meniscus lenses 54, 55 with surfaces curved toward the object, and a biconvex positive lens 56. The objective is closed off by a substantially plane-parallel closure plate 57 which is followed by the image plane 4 at an image-side working distance of about 8 mm.

The specification of the design is summarized in tabular form in Table 1, in which Column 1 gives the number of the refracting, reflecting, or otherwise designated surface F; Column 2 gives the radius r of the surface (in mm); and Column 3 gives the distance d, designated as thickness, of the surface to the next following surface (in mm). Column 4 gives the refractive index (designated as Index) of the material of the component which follows the entrance surface. The reflecting surfaces are characterized in Column 5. Column 6 gives the optically usable free diameter D of the optical components in mm. The total length L of the objective between the object and image planes is about 1,230 mm.

In the embodiment, seven of the surfaces, namely the surfaces F9 or F15, F23, F27, F30, F34, F41 and F49, are aspheric. The aspherics are characterized by double dashes in the Figure. Table 2 gives the corresponding aspheric data, the sagittae of the aspheric surfaces being calculated according to the following formula:

p(h)=[((1/r)h²)/(1+SQRT(1−(1+K)(1/r)²h²)]+C1*h⁴+C2*h⁶+. . .

Here the reciprocal (1/r) of the radius gives the surface curvature at the surface vertex, and h gives the distance of a surface point from the optical axis. Thus p(h) gives this sagitta, i.e., the distance of the surface point from the surface vertex in the z-direction, i.e., in the direction of the optical axis. The constants K, C1, C2, . . . are reproduced in Table 2.

The optical system 1 which can be reproduced using these data is designed for a working wavelength of 157 nm, at which the lens material, calcium fluoride, used for all the lenses has a refractive index n=1.55841. The image-side numerical aperture NA is 0.85, and the lateral magnification is 4:1. The system is designed for an image field size of 26×5.5 mm². The system is double-telecentric.

The function of the optical system and some advantageous distinctive features are described in detail hereinafter. Since no refractive power is present between the object plane 2 and the first fold 9, the angles arising between the optical axis 15 and the main ray or the marginal ray at the folding mirror 9 correspond exactly to the corresponding ray angles in the object plane 2. The folding of the ray path by more than 90° at the first deflecting mirror 9 is favorable for a large working distance over the whole width of the objective. The positive lens 20 arranged in the light path behind the first reflecting surface 9 between this and the concave mirror 6 is arranged in an optical neighborhood of the object plane 2, in which the main ray height of the outermost field point of the image is greater than the marginal ray height. The main ray height denotes here the ray height of a marginal field ray which crosses the optical axis in the region of the pupil. The marginal ray height denotes the ray height of a central field ray which leads to the edge of the system aperture. The positive refractive power arranged immediately behind the first folding mirror, in conjunction with the vanishing refractive power between the object plane and the first folding mirror, has the effect that with object-side telecentricity, the main rays of the imaging are incident axially parallel onto the first reflecting surface 9. In comparison with designs in which positive refractive power is arranged before the first folding mirror 9, this leads to clearly smaller angles of incidence of the radiation striking the first reflecting surface 9. These angles of incidence are not greater than 68° in the embodiment shown, a maximum angle of incidence of about 66° being present. The relatively small maximum angle of incidence make it possible to attain a largely uniform reflection at the folding mirror 9 over the whole angular bandwidth, using for the reflecting surface 9, reflecting coatings which are relatively simply built up. Furthermore, the positive lens 20 has a stronger refractive effect on the marginal rays of the imaging, due to a relatively large distance from the object plane 2 and thus greater marginal ray height. The diameter of the mirror group 12, and in particular of the concave mirror 6, can thereby be kept small, which gives advantages in manufacturing technique and in construction. If object-side telecentricity is not necessary or desired, the refractive power of the positive lens 20 arranged in the neighborhood of the object plane can be correspondingly reduced; this also affects the angle of incidence on the first mirror 9.

The two negative meniscus lenses 13, 14 directly before the concave mirror 6 provide for the correction of the chromatic longitudinal aberration CHL.

A further distinctive feature consists in that positive refractive power is also arranged in the light path between the concave mirror 6 and the second reflecting surface 10 in the immediate neighborhood of the reflecting surface. This is likewise supplied by the positive lens 20. The positive refractive power arranged before the second folding mirror 10 approximately collimates the principal ray and thus makes it possible to make the following lenses of the dioptric objective portion 8 with relatively small diameters, furthering a material-saving design.

The refractive powers of the lens region, consisting of the positive lens 20 and the mirror group 12, through which light passes immediately behind the first folding mirror 9, are adjusted so that the real intermediate image 3 of the imaging is arranged in the neighborhood of the second reflecting surface 10. More precisely, the paraxial intermediate image 25 is substantially situated on the lens surface 26, remote from the ray deflecting device 7, of the positive lens 20, and thus in the light path between the concave mirror 6 and the folding mirror 10 on the entrance side of the positive lens 20, while the marginal ray intermediate image is situated closer to the second reflecting surface but however in front of this. The intermediate image is thus preferably situated before the second reflecting surface 10, and to be precise, especially so that positive refractive power is still arranged between the paraxial intermediate image and this second reflecting surface. Since the intermediate image falls in the neighborhood of the second folding mirror 10, the étendue of the whole projection objective at constant field size can be minimized. The general symmetry of the arrangement, in which the pupil is situated in the neighborhood of the main mirror 6, requires that the lateral magnification βM of the catadioptric first objective portion is close to 1:1 and in general above about 0.95.

The simultaneous implementation of these requirements is facilitated in the embodiment shown, in that the positive refractive power provided in the immediate neighborhood of the reflecting surfaces 9, 10, and effective on the one hand in the light path between the first reflecting surface 9 and the concave mirror, and on the other hand in the light path between the concave mirror 6 and the second reflecting surface 10, is provided for by a single, integral, multi-region lens, namely the positive lens 20. It has a first lens region 30 through which light passes on the path from the first folding mirror 9 to the concave mirror 6, and a second lens region 31, through which light passes on the light path from the concave mirror 6 to the second folding mirror 10. The lens regions 30, 31 do not mutually overlap, neither on the side facing the folding mirror 9, nor on the side facing the mirror group 12, so that the lens regions are used completely independently of one another. Correspondingly, the optical effect of the lens regions 30, 31 can also be attained by two separate lenses. Uniting into a single lens however facilitates the construction of the objective.

A distinctive feature of the refractive second objective portion 8 consists in that at least one negative-positive lens group is present, in which a scattering air space is arranged between the negative lens and the following positive lens and can in particular have the geometrical shape of a convex-concave lens. Such lens sequences are especially favorable near the aperture diaphragm. In the example according to FIG. 1, two such lens groups 47, 48 and 49, 50 are present before the aperture diaphragm 60, in which a lens 47 or 49 with a concave surface on the image side is followed by an air space of meniscus shape.

The specification for the embodiment of a projection objective 100 according to FIG. 2 is given in Tables 3 and 4. The numbering of the optical elements or structural components corresponds to the numbering of the embodiment according to FIG. 1.

An essential difference from the embodiment according to FIG. 1 consists in that the multi-region lens 120 of positive refractive power, arranged in the immediate neighborhood of the folding mirrors 9, 10, is constructed as a “divided” lens. The region which includes the ray deflecting device 7 and the multi-region lens 120 is schematically shown enlarged for clarity in FIG. 3. In the multi-region lens 120, the lens surface 121 which faces the folding mirrors 9, 10 and is curved in this direction is physically divided such that the lens region 130 allocated to the first folding mirror 9 has a refractive power other than that of the lens region 131 allocated to the second folding mirror 10. This is effected by different curvatures of the entrance surface 123 and exit surface 124. Such multi-region lenses of different refractive power increase the design scope for such projection objectives.

In order to facilitate the manufacture of such a divided lens, it is provided in a preferred manufacturing process that the lens 120 is produced from a single blank. The two surface portions 123, 124 are to have a slight deformation, one relative to the other. This can be attained by simple means in that the surface designated as a divided surface 121 is first prefabricated in a known manner. The surface portion for which a surface shape deviating from this surface shape is planned is worked from the first surface portion by controlled polishing. Surface shaping using ion beams is preferably used of this purpose. The processing time is then substantially proportional to the necessary volume removal. In the embodiment shown in FIG. 2, the surface portion 124 is aspherized, while the surface portion 123 is spherical. Different curvatures of the lens regions 130, 131 can be simulated by the aspherizing in the respective optical ray paths, which are separate from each other. A significant widening of the design scope is thereby possible.

The embodiments shown in FIGS. 1 and 2 have a plane-parallel plate as a first optical element 11. This fulfills at least two important functions. Firstly, the internal space of the projection objective, flushed with helium in the exemplary objective, can be sealed off from the outer space, which can be flushed with nitrogen, for example. Furthermore, because of the planar boundary surface of the objective against the surrounding medium, the design is clearly more insensitive to pressure fluctuations. This is to be substantially ascribed to a reduced contribution of the Petzval sum and thus of the pressure dependence of the field curvature.

The specification for the embodiment of a projection objective 200 according to FIG. 4 is given in Tables 5 and 6. The numbering of the optical elements or of the optical structural components corresponds to the numbering for the preceding embodiments.

An essential difference from the above embodiments consists in that a negative refractive power is provided here between the object plane 2 and the first reflecting surface 9. This is provided for by a negative lens 211, which has a plane entrance surface and a concave exit surface, curved toward the object plane. The negative refractive power thereby supplied again reduces the angular loading on the first folding mirror 9, in comparison with the above embodiments, and frames the vignetting problems of the design favorably. Since the entry surface is planar, all the advantages of plane entrance surfaces relating to pressure stabilization are retained. The maximum angle of incidence can for example be reduced by about 0.3□ in comparison with the embodiment according to FIG. 1. The design modification is furthermore distinguished in that here the paraxial intermediate image 225 is situated at a clear distance in front of the lens surface, facing the main mirror 6, of the multi-region lens 220.

An embodiment is shown in FIG. 5 of a projection objective 300, whose specification is given in Tables 7 and 8. This design modification has, like the embodiment according to FIG. 1, a plane-parallel entrance element 311 and, arranged near the ray deflecting device 7, a double-spherical multi-region lens 320, which in other embodiments can also be at least partially constituted as an aspheric lens. A distinctive feature of the design consists in that here both the easily recognizable marginal ray image 326, and also the paraxial intermediate image (not shown) arranged nearer to the concave mirror, are arranged at a clear distance outside the multi-region lens 320, between this and the concave mirror. Thus the whole intermediate image is situated outside optical material. On both sides of the multi-region lens 320, the footprints of the ray paths do not overlap. This position of the intermediate image completely outside optical material on the side of the multi-region lens remote from the ray deflecting device can be of particular advantage when no optical material of high quality, in particularly of great material homogeneity, is to be used or can be used for the multi-region lens 320 because, for example, such material is not available or is too expensive. This is because imaging can be avoided in the image plane of possible defects present within the lens material. The design places higher requirements on corrective measures, since this position of the intermediate image corresponds to a spherical undercorrection which is opposed to a natural tendency of such systems to spherical overcorrection. The undercorrection of the intermediate image is here predominantly effected by a suitable shape of an aspheric in the mirror group.

It can be seen from FIG. 6 that many of the advantages described here can be used independently of what folding geometry is set using the ray deflecting device and possibly further reflecting surfaces. The design in FIG. 6 is derived from the design shown in FIG. 1, the shapes of the lenses remaining unchanged. Corresponding elements are therefore denoted by like reference numerals. The embodiment of the projection objective 1□ in FIG. 1 is distinguished in that the light coming from the object plane 2, after passing through the plane-parallel entrance plate 11 and the two positive lenses 20 used in two ray directions, first strikes the concave mirror 6, to be reflected from this in the direction of the first reflecting surface 9 of the ray deflecting device 7. A deflecting mirror 59 is arranged between the following transfer group 41 and the focusing group 42 which follows this, in order to make possible a parallel alignment of the object plane and image plane. The intermediate image 3 is here situated before the first reflecting surface 9, the paraxial intermediate image (not shown) being situated on the entrance surface of the positive lens 20 facing the concave mirror 6, and the marginal ray intermediate image being situated between this and the deflecting mirror 9. It can be seen that there are no optical components arranged in the space between the entrance plate 11 and the deflecting mirror 9, so that a compact, axially thickset constructional form is possible between the object plane and the ray deflecting device 7. It can also be seen that the spherical lens surface of the positive lens 20 facing the ray deflecting device 7 is independently used by the light beam running between the object plane and the concave mirror and the beam running between the concave mirror and the first reflecting surface 9, since the ray bundles do not overlap on this side. By suitable mutually deviating shaping of the lens regions 30, 31 allocated to the ray bundles, the optical effect of two independent lenses with different curvatures can thus be simulated by the integral multi-region lens 20.

FIG. 7 shows a catadioptric projection objective 400 which images an off-axis object field situated in the object plane 2 by means of an uncorrected intermediate image 3 into a rectangular image field of size 26 mm×8 mm arranged in the image plane 4, at a reduction lateral magnification of 4:1 with an image-side numerical aperture NA=0.80. The wavefront correction in the image field is approximately 1% r.m.s. of the wavelength (157 nm) over the whole field.

The intermediate image 3 is produced by a catadioptric, first objective portion 5 with a geometric beamsplitter 7, the first reflecting surface 9 being the reflecting back side of a prism 401. The light passes twice through the group of two negative lenses arranged close to the concave mirror 6. The second reflecting surface 10 of the ray deflecting device is arranged near the intermediate image. The following, refractive second objective portion 8 has an aperture diaphragm plane 402 and is constructed according to known techniques. Aspheric lens surfaces serve to reduce the number of lenses with regard to the requirements for high NA and the transmission problems at 157 nm, and also the availability and price of calcium fluoride lenses. A pre-compensation for the axial color errors and the rise of the Petzval sum which are introduced by the positive lenses is provided by the negative lenses of the mirror group 12.

The optical axis 15 at the object field and the optical axis 16 in the refractive second objective portion 8 are parallel, in order to attain a parallel placement of the object plane and image plane. In addition, they are coaxial, or are only slightly mutually displaced laterally. The optical axis 17 of the portion between the folding mirrors 9, 10 and the concave mirror deviates therefrom at an optimum angle in order to make possible a vignetting-free arrangement of the folding mirrors 9, 10. Other folding variants are likewise possible within the scope of the design, for example, a h-folding corresponding to FIG. 6.

An axial region 404 in which the ray bundle going from the object to the concave mirror and the ray bundle returning from the concave mirror to the intermediate image 3 go separately from one another and do not overlap each other is situated between the ray deflecting device 7 with the folding mirrors 9, 10 and the concave mirror 6. This is the consequence of the geometric ray division, in contrast to the physical ray division in other types of catadioptric projection objective. Two half lenses or truncated lenses 405, 406, which are a distinctive feature of this design, are arranged in the region 404 through which two light beams pass separately, going past one another. The half lenses 405, 406 respectively have positive refractive power, so that the diameter of the ray bundle is kept small in the region of the mirror group 12. Furthermore, the division of the ray bundle in the deflecting mirrors 9, 10 is simplified, and the off-axis deviation of the object field can be reduced. The refractive power of the positive half lens 405 arranged near the object plane affects the object-side telecentricity, so that telecentric and non-telecentric variants are possible by suitable choice of the refractive power. If necessary, the half lens 405, i.e., the positive refractive power between the object plane and concave mirror, can even be omitted.

Both half lenses 405 and 406 have refracting surfaces which are rotationally symmetrical in relation to the optical axis 17 of the objective portion leading to the concave mirror. Correspondingly, the whole projection objective is a centered optical system.

In the first half lens 405 arranged between the first mirror 9 and the concave mirror 6, the surface with the greater curvature faces the object field, while the second half lens 406 has its more strongly curved lens surface on the side remote from the second reflecting surface 10 and facing the concave mirror 6. Thus the ray entrance surfaces are more strongly curved than the ray exit surfaces. The ray divergence in the second half lens 406 is greater than that in the first half lens 405, since the combination of the concave mirror 6 and the negative lens preceding it has a reducing lateral magnification. Correspondingly, the half lenses 405, 406 have different correcting effects on the imaging. This cannot be attained by means of a single rotationally symmetrical lens in place of the two half lenses.

In this design, a field lens between the object plane 2 and the first reflecting surface 9 is optional. The ray division and folding can be attained by plane deflecting mirrors or by back faces of prisms. A telecentric and also a holocentric arrangement of the main ray are both possible. The arrangement of the intermediate image 3 in the neighborhood of a folding mirror is advantageous for the reduction or avoidance of vignetting. If only one lens surface is different for the two ray bundles, then preferably the sides near the object field or near the intermediate image are selected for this purpose, in order to attain a stronger effect on field-specific aberrations. Vignetting effects can be reduced by the measures described here, to an extent that the object field can be moved close to the neighborhood of the optical axis, with the consequence that the field radius to be corrected is small. This reduces the required lens diameter, favoring a material-saving design. The correction of image errors is simplified by the additional degrees of freedom for the design.

In the described embodiments, all the transparent optical components consist of the same material, namely calcium fluoride. Other materials which are transparent at the working wavelength can also be used if necessary, in particular the fluoride crystal materials mentioned at the beginning. If necessary at least one second material can also be used, for example in order to support chromatic correction. The advantages of the invention can of course also be used in systems for other working wavelengths of the ultraviolet region, for example, for 248 nm or 193 nm. Since only one lens material is used in the embodiments shown, it is possible particularly easily for a person skilled in the art to adapt the shown design to other wavelengths. In particular, in systems for longer wavelengths, other lens materials, for example synthetic quartz glass, can be used for some or all optical components.

It is also possible to construct some of the described projection objectives with physical ray division. In particular, the ray deflecting device can have a first and a second reflecting surface, the reflecting surfaces being constructed as polarization selective reflecting surfaces which can geometrically coincide. The reflecting surfaces can be arranged, for example, in a beamsplitter block (BSC).

Projection objectives according to the invention can be used in all suitable microlithographic projection exposure apparatuses, for example in a wafer stepper or a wafer scanner. A wafer scanner 150 is schematically shown in FIG. 8 by way of example. It includes a laser light source 151 with an associated device for narrowing the bandwidth of the laser. An illumination system 153 produces a large, sharply bounded and very homogeneously illuminated image field, which is adapted to the telecentricity requirements of the succeeding projection objective 1. The illumination system 153 has devices for the selection of the mode of illumination and is, for example, switchable between conventional illumination with variable degree of coherence, annular field illumination, and dipole or quadrupole illumination. Behind the illumination system is a device 154 for holding and manipulating a mask 155, arranged so that the mask 155 is situated in the image plane 2 of the projection objective 1, and is movable in this plane for scanning operation. The device 154 correspondingly includes a scanning drive in the case of the wafer scanner shown.

The reduction objective 1 follows behind the mask plane 2, and images the mask at a reduced magnification ratio onto a wafer 156 coated with a photoresist layer and arranged in the image plane 4 of the reduction objective 1. The wafer 156 is held by a device 157 which includes a scanner drive in order to move the wafer synchronously with the reticle. All the systems are controlled by a control unit 158. The construction of such a system, and also its manner of operation, are known per se and are therefore not further described.

TABLE 1

| Surface | Radius | Thickness | Index | Refl. | D |
|---|---|---|---|---|---|
| 0 | 0.0000 | 36.0000 | | | 134.0 |
| 1 | 0.0000 | 0.0000 | | | 146.5 |
| 2 | 0.0000 | 10.0000 | 1.55841 | | 146.5 |
| 3 | 0.0000 | 75.0000 | | | 148.7 |
| 4 | 0.0000 | 0.0000 | | REFL | 202.3 |
| 5 | 0.0000 | −15.0000 | | | 176.6 |
| 6 | −344.5436 | −24.6200 | 1.55841 | | 187.3 |
| 7 | 4353.9901 | −476.0730 | | | 187.7 |
| 8 | 250.8035 | −15.0000 | 1.55841 | | 219.5 |
| 9 | 899.5097 | −27.7430 | | | 232.4 |
| 10 | 234.4913 | −15.0000 | 1.55841 | | 234.7 |
| 11 | 770.4531 | −30.4280 | | | 259.5 |
| 12 | 258.9157 | 30.4280 | | REFL | 264.4 |
| 13 | 770.4531 | 15.0000 | 1.55841 | | 257.4 |
| 14 | 234.4913 | 27.7430 | | | 230.4 |
| 15 | 899.5097 | 15.0000 | 1.55841 | | 227.2 |
| 16 | 250.8035 | 476.0730 | | | 213.1 |
| 17 | 0.0000 | 0.0000 | | | 141.0 |
| 18 | 4353.9901 | 24.6200 | 1.55841 | | 140.9 |
| 19 | −344.5436 | −3.0000 | | | 139.9 |
| 20 | 0.0000 | 0.0000 | | REFL | 155.4 |
| 21 | 0.0000 | −119.0000 | | | 138.4 |
| 22 | −267.8818 | −30.0500 | 1.55841 | | 177.2 |
| 23 | −576.5334 | −41.6440 | | | 176.8 |
| 24 | 267.9465 | −30.0500 | 1.55841 | | 180.1 |
| 25 | 273.9674 | −93.7130 | | | 190.6 |
| 26 | −496.4337 | −30.0500 | 1.55841 | | 212.6 |
| 27 | −387.4885 | −27.3640 | | | 211.3 |
| 28 | −3333.8251 | −30.0500 | 1.55841 | | 215.5 |
| 29 | 454.1648 | −256.5570 | | | 218.2 |
| 30 | −629.8867 | −10.0500 | 1.55841 | | 224.1 |
| 31 | −195.0941 | −13.0000 | | | 220.9 |
| 32 | −246.4630 | −40.3280 | 1.55841 | | 225.5 |
| 33 | 2288.9102 | −1.3000 | | | 226.0 |
| 34 | −300.8609 | −10.0500 | 1.55841 | | 226.4 |
| 35 | −176.6095 | −26.2730 | | | 219.5 |
| 36 | −239.6605 | −38.8460 | 1.55841 | | 229.2 |
| 37 | 16311.7034 | −23.1970 | | | 228.6 |
| 38 | 0.0000 | 7.1350 | | | 225.8 |
| 39 | −253.1435 | −56.9530 | 1.55841 | | 229.5 |
| 40 | 330.6107 | −8.5400 | | | 227.2 |
| 41 | 342.9067 | −18.2840 | 1.55841 | | 218.0 |
| 42 | −165.1076 | −14.6820 | | | 200.5 |
| 43 | −222.6188 | −49.8860 | 1.55841 | | 203.4 |
| 44 | 348.3621 | −1.3000 | | | 202.7 |
| 45 | −143.5651 | −37.2220 | 1.55841 | | 180.6 |
| 46 | −358.4291 | −1.3000 | | | 167.9 |
| 47 | −194.9258 | −37.1660 | 1.55841 | | 159.2 |
| 48 | −1285.1182 | −1.6400 | | | 137.5 |
| 49 | −172.6577 | −48.8030 | 1.55841 | | 120.5 |
| 50 | 1719.9216 | −1.2000 | | | 73.1 |
| 51 | 0.0000 | −10.0000 | 1.55841 | | 68.2 |
| 52 | 0.0000 | −8.0000 | | | 56.0 |
| 53 | 0.0000 | 0.0000 | | | 33.5 |

TABLE 2
Aspherics

| Surface | K | C1 | C2 | C3 | C4 | C5 |
|---|---|---|---|---|---|---|
| 9 | 0.0000 | 1.0033E−08 | −2.1576E−13 | 1.5293E−18 | 4.1306E−23 | −9.0704E−27 |
| 15 | 0.0000 | 1.0033E−08 | −2.1576E−13 | 1.5293E−18 | 4.1306E−23 | −9.0704E−27 |
| 23 | 0.0000 | −6.9855E−09 | −5.6982E−14 | 3.5079E−19 | −3.6907E−23 | 1.9575E−27 |
| 27 | 0.0000 | −8.5198E−09 | 1.6320E−14 | −3.1084E−19 | 2.2299E−23 | −7.9900E−28 |
| 30 | 0.0000 | 3.7040E−09 | −2.2096E−13 | 8.7668E−18 | −1.2775E−22 | 1.3521E−26 |
| 34 | 0.0000 | 6.7737E−09 | 6.7716E−14 | −3.9157E−18 | 1.7628E−22 | −2.7036E−26 |
| 41 | 0.0000 | 1.7799E−08 | −1.5023E−12 | 7.4806E−17 | −2.8690E−21 | 7.4224E−26 |
| 49 | 0.0000 | 5.4176E−08 | 4.5781E−12 | 4.2158E−17 | 1.8517E−21 | −2.8299E−24 |

TABLE 3

| Surface | Radius | Thickness | Index | Refl. | D |
|---|---|---|---|---|---|
| 0 | 0.0000 | 36.0000 | | | 134.0 |
| 1 | 0.0000 | 0.0000 | | | 146.5 |
| 2 | 0.0000 | 10.0000 | 1.55841 | | 146.5 |
| 3 | 0.0000 | 75.0000 | | | 148.7 |
| 4 | 0.0000 | 0.0000 | | REFL | 202.3 |
| 5 | 0.0000 | −15.0000 | | | 176.6 |
| 6 | −332.0908 | −24.5940 | 1.55841 | | 187.5 |
| 7 | 9972.9744 | −476.9880 | | | 187.8 |
| 8 | 243.4102 | −15.0000 | 1.55841 | | 219.5 |
| 9 | 738.8948 | −27.3440 | | | 232.6 |
| 10 | 227.7530 | −15.0000 | 1.55841 | | 234.9 |
| 11 | 727.1156 | −29.7880 | | | 260.4 |
| 12 | 260.0106 | 29.7880 | | REFL | 265.3 |
| 13 | 727.1156 | 15.0000 | 1.55841 | | 258.4 |
| 14 | 227.7530 | 27.3440 | | | 230.2 |
| 15 | 738.8948 | 15.0000 | 1.55841 | | 227.0 |
| 16 | 243.4102 | 476.9880 | | | 212.9 |
| 17 | 0.0000 | 0.0000 | | | 140.6 |
| 18 | 9972.9744 | 24.5940 | 1.55841 | | 140.6 |
| 19 | −324.8209 | −3.0000 | | | 139.6 |
| 20 | 0.0000 | 0.0000 | | REFL | 155.7 |
| 21 | 0.0000 | −119.0000 | | | 138.2 |
| 22 | −339.9996 | −16.2900 | 1.55841 | | 176.7 |
| 23 | −688.1303 | −24.3070 | | | 177.1 |
| 24 | 339.5889 | −30.0500 | 1.55841 | | 178.6 |
| 25 | 342.9462 | −82.8630 | | | 188.2 |
| 26 | −278.5659 | −10.4090 | 1.55841 | | 213.2 |
| 27 | −262.2800 | −34.7850 | | | 211.2 |
| 28 | −2379.1678 | −30.0500 | 1.55841 | | 215.5 |
| 29 | 477.6765 | −313.2180 | | | 217.9 |
| 30 | −718.9659 | −10.0500 | 1.55841 | | 224.0 |
| 31 | −198.9422 | −13.4400 | | | 221.0 |
| 32 | −259.1793 | −40.2620 | 1.55841 | | 225.3 |
| 33 | 1506.1087 | −1.3000 | | | 226.0 |
| 34 | −301.6161 | −10.0500 | 1.55841 | | 226.5 |
| 35 | −178.5990 | −24.7150 | | | 220.0 |
| 36 | −245.3120 | −37.5920 | 1.55841 | | 228.5 |
| 37 | 100461.9872 | −25.1330 | | | 228.1 |
| 38 | 0.0000 | 16.3190 | | | 225.8 |
| 39 | −245.4430 | −58.0340 | 1.55841 | | 228.4 |
| 40 | 320.4148 | −9.5780 | | | 226.3 |
| 41 | 302.9113 | −22.1920 | 1.55841 | | 217.7 |
| 42 | −169.4134 | −14.2420 | | | 201.5 |
| 43 | −227.5800 | −51.6750 | 1.55841 | | 204.5 |
| 44 | 312.0379 | −1.3000 | | | 204.2 |
| 45 | −140.9689 | −37.4020 | 1.55841 | | 180.3 |
| 46 | −390.1742 | −1.3000 | | | 168.4 |
| 47 | −210.2591 | −37.5460 | 1.55841 | | 159.7 |
| 48 | −1051.5017 | −1.3000 | | | 135.7 |
| 49 | −177.0965 | −48.5830 | 1.55841 | | 120.4 |
| 50 | 1433.5516 | −1.2000 | | | 73.3 |
| 51 | 0.0000 | −10.0000 | 1.55841 | | 68.2 |
| 52 | 0.0000 | −8.0000 | | | 56.0 |
| 53 | 0.0000 | 0.0000 | | | 33.5 |

TABLE 4
Aspherics

| Surface | K | C1 | C2 | C3 | C4 | C5 |
|---|---|---|---|---|---|---|
| 9 | 0.0000 | 8.4764E−09 | −1.7396E−13 | 6.8534E−19 | 4.7527E−23 | −7.6484E−27 |
| 15 | 0.0000 | 8.4764E−09 | −1.7396E−13 | 6.8534E−19 | 4.7527E−23 | −7.6484E−27 |
| 19 | 0.0000 | 7.6662E−09 | −1.4503E−13 | 2.2501E−18 | 1.3341E−22 | −9.3064E−27 |
| 23 | 0.0000 | 6.1832E−09 | −3.4635E−13 | 7.1709E−18 | −1.5994E−22 | 3.0136E−27 |
| 27 | 0.0000 | −1.1101E−08 | 1.1415E−13 | −1.0141E−18 | 1.7447E−23 | −4.6467E−28 |
| 30 | 0.0000 | 2.6577E−09 | −2.5288E−13 | 9.6253E−18 | −1.7874E−22 | 1.2375E−26 |
| 34 | 0.0000 | 7.1212E−09 | 9.3949E−14 | −3.0034E−18 | 1.7889E−22 | −1.8179E−26 |
| 41 | 0.0000 | 1.6292E−08 | −1.4584E−12 | 6.7046E−17 | −2.5613E−21 | 6.2671E−26 |
| 49 | 0.0000 | 4.5064E−08 | 4.5991E−12 | 4.7389E−17 | 2.4279E−20 | −4.3120E−24 |

TABLE 5

| Surface | Radius | Thickness | Index | Refl. | D |
|---|---|---|---|---|---|
| 0 | 0.0000 | 36.0000 | | | 134.0 |
| 1 | 0.0000 | 0.0000 | | | 146.5 |
| 2 | 21839.4165 | 10.0000 | 1.55841 | | 146.5 |
| 3 | 1144.1450 | 75.0000 | | | 149.3 |
| 4 | 0.0000 | 0.0000 | | REFL | 202.2 |
| 5 | 0.0000 | −15.0000 | | | 181.7 |
| 6 | −355.0931 | −29.4960 | 1.55841 | | 194.9 |
| 7 | 1016.5480 | −498.1790 | | | 195.7 |
| 8 | 256.2069 | −15.0000 | 1.55841 | | 219.4 |
| 9 | 986.7774 | −27.9590 | | | 231.7 |
| 10 | 235.6173 | −15.0000 | 1.55841 | | 234.1 |
| 11 | 781.0837 | −30.0860 | | | 258.9 |
| 12 | 260.9988 | 30.0860 | | REFL | 263.9 |
| 13 | 781.0837 | 15.0000 | 1.55841 | | 257.3 |
| 14 | 235.6173 | 27.9590 | | | 229.5 |
| 15 | 986.7774 | 15.0000 | 1.55841 | | 226.5 |
| 16 | 256.2069 | 491.1320 | | | 212.8 |
| 17 | 0.0000 | 7.0470 | | | 144.3 |
| 18 | 1016.5480 | 29.4960 | 1.55841 | | 143.7 |
| 19 | −355.0931 | 1.0000 | | | 141.9 |
| 20 | 0.0000 | 0.0000 | | REFL | 166.4 |
| 21 | 0.0000 | −115.0000 | | | 140.2 |
| 22 | −256.6617 | −17.1490 | 1.55841 | | 177.5 |
| 23 | −495.7192 | −37.8010 | | | 176.7 |
| 24 | 200.0765 | −30.0500 | 1.55841 | | 177.7 |
| 25 | 216.7185 | −73.0740 | | | 189.9 |
| 26 | −479.6895 | −27.0640 | 1.55841 | | 204.5 |
| 27 | −275.1516 | −23.5570 | | | 202.2 |
| 28 | −1589.3959 | −26.4070 | 1.55841 | | 205.0 |
| 29 | 442.3719 | −267.3480 | | | 207.1 |
| 30 | −492.2609 | −10.0500 | 1.55841 | | 224.2 |
| 31 | −193.6583 | −14.4370 | | | 220.7 |
| 32 | −250.1179 | −41.3440 | 1.55841 | | 225.7 |
| 33 | 1527.5797 | −1.3000 | | | 226.1 |
| 34 | −313.3351 | −10.0500 | 1.55841 | | 225.7 |
| 35 | −175.5446 | −24.9390 | | | 218.5 |
| 36 | −244.0942 | −39.3320 | 1.55841 | | 226.6 |
| 37 | 2832.5746 | −22.5340 | | | 226.0 |
| 38 | 0.0000 | 3.1440 | | | 222.2 |
| 39 | −256.2323 | −55.9230 | 1.55841 | | 226.0 |
| 40 | 318.8356 | −10.2830 | | | 223.8 |
| 41 | 313.0513 | −15.4320 | 1.55841 | | 213.7 |
| 42 | −179.6546 | −14.8330 | | | 199.1 |
| 43 | −256.2496 | −47.7600 | 1.55841 | | 201.4 |
| 44 | 306.7205 | −1.3000 | | | 200.9 |
| 45 | −138.4973 | −33.6720 | 1.55841 | | 176.2 |
| 46 | −329.2081 | −1.3000 | | | 165.4 |
| 47 | −187.5977 | −35.6060 | 1.55841 | | 156.8 |
| 48 | −1130.2595 | −1.3000 | | | 136.0 |
| 49 | −182.0617 | −48.1120 | 1.55841 | | 120.5 |
| 50 | 2218.3519 | −1.2000 | | | 72.8 |
| 51 | 0.0000 | −10.0000 | 1.55841 | | 68.2 |
| 52 | 0.0000 | −8.0000 | | | 56.0 |
| 53 | 0.0000 | 0.0000 | | | 33.5 |

TABLE 6
Aspherics

| Surface | K | C1 | C2 | C3 | C4 | C5 |
|---|---|---|---|---|---|---|
| 9 | 0.0000 | 8.8766E−09 | −1.6957E−13 | 1.8589E−18 | 3.8812E−23 | −6.3105E−27 |
| 15 | 0.0000 | 8.8766E−09 | −1.6957E−13 | 1.8589E−18 | 3.8812E−23 | −6.3105E−27 |
| 23 | 0.0000 | −8.8840E−09 | −4.4228E−14 | 4.0748E−19 | −1.8437E−23 | 1.3396E−27 |
| 27 | 0.0000 | −4.1443E−09 | 5.8326E−14 | −5.8462E−19 | 1.9357E−23 | −9.7708E−28 |
| 30 | 0.0000 | 3.0781E−09 | −2.9796E−13 | 1.1966E−17 | −1.6682E−22 | 1.6934E−26 |
| 34 | 0.0000 | 6.6799E−09 | 1.7313E−13 | −7.0332E−18 | 1.9545E−22 | −3.2080E−26 |
| 41 | 0.0000 | 1.7470E−08 | −1.3609E−12 | 6.7295E−17 | −2.6059E−21 | 6.6203E−26 |
| 49 | 0.0000 | 4.6366E−08 | 4.3489E−12 | 2.0059E−16 | 2.4690E−22 | −4.0588E−25 |

TABLE 7

| Surface | Radius | Thickness | Index | Refl. | D |
|---|---|---|---|---|---|
| 0 | 0.0000 | 36.000 | | | 136 |
| 1 | 0.0000 | 0.000 | | | 148.3 |
| 2 | 0.0000 | 10.000 | 1.55841 | | 148.3 |
| 3 | 0.0000 | 73.722 | | | 150.5 |
| 4 | 0.0000 | 0.000 | | REFL | 205.1 |
| 5 | 0.0000 | −30.000 | | | 177.6 |
| 6 | −510.2342 | −26.568 | 1.55841 | | 192.6 |
| 7 | 729.1643 | −441.119 | | | 193.7 |
| 8 | 269.7387 | −12.500 | 1.55841 | | 213.9 |
| 9 | 1095.3095 | −37.603 | | | 223.9 |
| 10 | 184.8893 | −12.500 | 1.55841 | | 226.2 |
| 11 | 496.0801 | −26.337 | | | 253 |
| 12 | 244.3368 | 26.337 | | REFL | 258.3 |
| 13 | 496.0801 | 12.500 | 1.55841 | | 249.6 |
| 14 | 184.8893 | 37.603 | | | 214.1 |
| 15 | 1095.3095 | 12.500 | 1.55841 | | 208.9 |
| 16 | 269.7387 | 431.119 | | | 198 |
| 17 | 0.0000 | 10.000 | | | 132.5 |
| 18 | 729.1643 | 26.568 | 1.55841 | | 141.5 |
| 19 | −510.2342 | 16.000 | | | 147.5 |
| 20 | 0.0000 | 0.000 | | REFL | 197 |
| 21 | 0.0000 | −115.000 | | | 155.4 |
| 22 | −228.3659 | −29.178 | 1.55841 | | 210.5 |
| 23 | −755.0389 | −36.199 | | | 209.3 |
| 24 | 288.7379 | −30.050 | 1.55841 | | 209.3 |
| 25 | 271.3506 | −102.135 | | | 216.9 |
| 26 | −3740.0722 | −30.050 | 1.55841 | | 212.4 |
| 27 | −17470.9183 | −81.304 | | | 212 |
| 28 | −270.1438 | −16.361 | 1.55841 | | 211.6 |
| 29 | −372.2562 | −77.136 | | | 208.7 |
| 30 | 145.7447 | −10.050 | 1.55841 | | 206 |
| 31 | 166.6588 | −69.439 | | | 214 |
| 32 | 684.5024 | −16.923 | 1.55841 | | 217.8 |
| 33 | 346.1324 | −1.300 | | | 219.2 |
| 34 | −476.4704 | −10.050 | 1.55841 | | 216.5 |
| 35 | −176.0415 | −25.156 | | | 210.1 |
| 36 | −379.2686 | −29.149 | 1.55841 | | 213.5 |
| 37 | 1298.9533 | −36.351 | | | 214.9 |
| 38 | 0.0000 | 35.051 | | | 219.8 |
| 39 | −226.6203 | −24.334 | 1.55841 | | 219.7 |
| 40 | −458.4752 | −1.300 | | | 217.1 |
| 41 | −167.6660 | −34.535 | 1.55841 | | 218.2 |
| 42 | −320.7207 | −10.842 | | | 211.9 |
| 43 | −457.0800 | −16.137 | 1.55841 | | 210.2 |
| 44 | −151.6130 | −20.816 | | | 195.2 |
| 45 | −250.6503 | −42.717 | 1.55841 | | 197.1 |
| 46 | 360.2602 | −1.300 | | | 196.2 |
| 47 | −237.7582 | −24.979 | 1.55841 | | 183.1 |
| 48 | −2361.7106 | −1.300 | | | 178.1 |
| 49 | −139.7121 | −87.106 | 1.55841 | | 158.6 |
| 50 | 875.7082 | −1.300 | | | 98.4 |
| 51 | −250.3316 | −13.440 | 1.55841 | | 85 |
| 52 | 6786.8801 | −1.391 | | | 73 |
| 53 | 0.0000 | −10.000 | 1.55841 | | 68.4 |
| 54 | 0.0000 | −8.000 | | | 56.3 |
| 55 | 0.0000 | 0.000 | | | 34 |

TABLE 8
Aspherics

| Surface | K | C1 | C2 | C3 | C4 | C5 | C6 |
|---|---|---|---|---|---|---|---|
| 9 | 0.0000 | 8.8068E−09 | −2.2357E−13 | 3.8818E−18 | 1.1343E−22 | −4.9744E−26 | 5.5024E−30 |
| 15 | 0.0000 | 8.8068E−09 | −2.2357E−13 | 3.8818E−18 | 1.1343E−22 | −4.9744E−26 | 5.5024E−30 |
| 22 | 0.0000 | 5.9182E−09 | 9.8467E−14 | 3.2348E−18 | −1.4579E−23 | 8.1375E−27 | −1.3307E−31 |
| 26 | 0.0000 | 1.2698E−08 | −1.2953E−13 | −8.7759E−18 | −1.5329E−22 | −1.5718E−26 | 7.5962E−32 |
| 33 | 0.0000 | −1.4957E−08 | 2.4830E−13 | −7.6975E−18 | 1.3806E−21 | −1.5868E−26 | |
| 34 | 0.0000 | −1.1079E−09 | 1.3889E−14 | 8.3401E−18 | 6.4570E−22 | −2.2809E−26 | 6.0922E−30 |
| 41 | 0.0000 | 8.3902E−09 | 3.2806E−13 | 9.3886E−19 | −1.1478E−21 | 5.2141E−26 | |
| 46 | 0.0000 | −5.6112E−09 | 7.4939E−14 | −3.7772E−17 | −1.4124E−22 | −6.5393E−26 | |
| 47 | 0.0000 | 1.8509E−08 | −2.1463E−14 | 8.0276E−18 | −4.4509E−21 | 3.7602E−25 | |

1. Catadioptric projection objective for imaging a pattern arranged in an object plane into an image plane, with the production of a real intermediate image, wherein
arranged between the object plane and the image plane are a catadioptric first objective portion with a concave mirror and a ray deflecting device, and behind the ray deflecting device a second objective portion, which is preferably dioptric;
the ray deflecting device has a first reflecting surface for deflecting the radiation coming from the object plane to the concave mirror; and
positive refractive power is arranged behind the first reflecting surface, between the first reflecting surface and the concave mirror, in an optical neighborhood of the object plane.

2. Projection objective according to claim 1, wherein, in the optical neighborhood of the object plane, the principal ray height of the outermost field point of the imaging is greater than the marginal ray height.

3. Projection objective according to claim 1 or 2, wherein the ray deflecting device has a second reflecting surface for deflecting the radiation coming from the concave mirror to the second objective portion, and the intermediate image is arranged in the neighborhood of the second reflecting surface.

4. Projection objective according to claim 3, wherein the intermediate image is arranged before the second reflecting surface.

5. Projection objective according to one of the foregoing claims, wherein positive refractive power is arranged in the neighborhood of the intermediate image, in particular between the intermediate image and a second reflecting surface of the ray deflecting device.

6. Projection objective according to one of the foregoing claims, wherein the catadioptric first objective portion has a lateral magnification β_{M}>0.95, preferably having a lateral magnification close to βM=1.

7. Projection objective according to one of the foregoing claims, wherein the first reflecting surface is arranged obliquely of the optical axis of the projection objective at an angle of inclination deviating from 45°, the angle of inclination preferably being between about 50° and about 55°.

8. Projection objective according to one of the foregoing claims, wherein the angle of incidence of the radiation striking the first reflecting surface is not greater than α₀, where
$${α}_{0} = \vert arcsin ( {β}^{*} NA \vert + \frac{{α}_{HOA}}{2}$$
where β is the lateral magnification of the projection objective, NA is the image-side numerical aperture, and α_{HOA} is the angle included by a portion of the optical axis running perpendicularly to the object plane and a portion of the optical axis arising by folding at the first reflecting surface.

9. Projection objective according to one of the foregoing claims, wherein a single lens with positive refractive power is arranged in the optical neighborhood of the object plane, behind the first reflecting surface.

10. Projection objective according to one of the foregoing claims, wherein at least one multi-region lens is arranged in a double-pass region, in particular between the ray deflecting device and the concave mirror, and has a first lens region through which light passes in a first direction, and a second lens region through which light passes in a second direction, with the first lens region and the second lens not overlapping on at least one side of the lens.

11. Projection objective according to one of the foregoing claims, wherein at least one multi-region lens is provided, with at least two adjacently situated lens regions with different refractive properties, the multi-region lens preferably being of integral construction.

12. Projection objective according to claim 11, wherein the multi-region lens has a first and a second lens surface, and only one of the lens surfaces has regions of different curvature.

13. Projection objective according to claim 11 or 12, wherein the multi-region lens has at least one lens surface which is aspheric in at least one region.

14. Projection objective according to claim 13, wherein the multi-region lens has at least one lens surface with regions of different curvature, at least one of these regions being aspheric.

15. Projection objective according to one of the foregoing claims, wherein the ray deflecting device has a fully reflecting first reflecting surface for deflecting the radiation coming from the object plane to the concave mirror and a fully reflecting second reflecting surface, arranged at an angle to the first reflecting surface, for deflecting the radiation coming from the concave mirror to the second objective portion.

16. Projection objective according to claim 15, wherein the first and the second reflecting surfaces are formed on a ray deflecting prism.

17. Projection objective according to one of the foregoing claims, wherein no positive refractive power is arranged in a space geometrically between the object plane and the first reflecting surface.

18. Projection objective according to one of the foregoing claims, wherein no, or only little, refractive power is arranged between the object plane and the first reflecting surface.

19. Projection objective according to claims 1-17, wherein negative refractive power is arranged between the object plane and the first reflecting surface.

20. Projection objective according to one of the foregoing claims, wherein a first optical element immediately following the object plane has a substantially planar entrance surface.

21. Projection objective according to one of the foregoing claims, wherein the first optical element is a negative lens.

22. Projection objective according to one of the foregoing claims, wherein the projection objective is telecentric on the object side and on the image side.

23. Projection objective according to one of the foregoing claims, wherein it is designed for ultraviolet light having a wavelength between about 120 nm and about 260 nm, in particular for working wavelengths of about 157 nm or about 193 nm.

24. Projection objective according to one of the foregoing claims, wherein it has an image-side numerical aperture NA of more than 0.7, the image-side numerical aperture NA preferably being at least 0.8, in particular about 0.85.

25. Projection exposure apparatus for microlithography with an illumination system and a catadioptric projection objective, wherein the projection objective is constituted according to one of the foregoing claims.

26. Process for the production of semiconductor structural elements and other fine-structured components with the following steps:
preparation of a mask with a predetermined pattern;
illumination of the mask with ultraviolet light of a predetermined wavelength; and
projection of an image of the pattern onto a photosensitive substrate arranged in the region of the image plane of a projection objective, using a catadioptric projection objective according to one of claims 1-24.

27. Catadioptric projection objective for the imaging of a pattern arranged in an object plane into an image plane, with the production of a real intermediate image, wherein
a catadioptric first objective portion with a single concave mirror and a geometrical ray deflecting device, and behind the ray deflecting device a preferably dioptric second objective portion, are arranged between the object plane and the image plane;
at least one plane aligned perpendicular to an optical axis is present, in which a first ray bundle going in the direction toward the concave mirror and a second ray bundle returning from the concave mirror go past one another without overlapping; and
a lens arrangement is arranged in the region of this plane and has different optical effects on the first ray bundle and the second ray bundle.

28. Projection objective according to claim 27, wherein the lens arrangement has at least one truncated lens, which is arranged in the region of the plane such that one of the ray bundles is refracted and the truncated lens does not extend into the other ray bundle.

29. Projection objective according to claim 27, wherein the lens arrangement has two truncated lenses which are arranged adjacent to one another.

30. Projection objective according to claim 27, wherein the lens arrangement includes a disk-shaped, transparent member, and at least one truncated lens is secured to the transparent member.

31. Projection objective according to claim 30, wherein the transparent member is a lens or a plane-parallel plate.

32. Projection objective according to claim 30, wherein at least one truncated lens is secured to the transparent member by wringing or adhering.

33. Projection objective according to claim 28, wherein a truncated lens which is arranged in the region of the first or the second ray bundle has positive refractive power.

34. Projection objective according to claim 27, wherein the lens arrangement includes a multi-region lens which has a first lens region passed through in a first direction of passage and a second region passed through in a second direction of passage, the first lens region and the second lens region not overlapping one another on at least one side of the multi-region lens.

35. Projection objective according to claim 34, wherein the multi-region lens has two lens surfaces and at least one of the lens surfaces is differently curved in a first region through which a first ray bundle passes and in a second region through which a second ray bundle passes.

36. Projection objective according to claim 34, wherein lenses arranged in the region of the plane form a lens group which has positive refractive power in a lens region.

37. Projection objective according to claim 34, wherein the multi-region lens has at least one lens surface which is aspheric in a first region and in a second region, and the regions respectively have an aspheric shape with a common spherical basis and different aspheric deviations from the common spherical basis.

38. Projection objective according to claim 27, wherein lenses which are arranged in the region of the plane are rotationally-symmetrically curved relative to the optical axis.

39. Projection objective according to claim 34, wherein a group of optical elements having the concave mirror and possibly one or more double-pass lenses has a lateral magnification substantially deviating from 1, the lateral magnification being between 0.5 and 0.95 or between 1.05 and 1.2.

40. Multi-region lens for a projection objective, in particular for a catadioptric projection objective, wherein the multi-region lens has a first lens region and a second lens region arranged near the first lens region, the lens regions having different refractive power.

41. Multi-region lens according to claim 40, wherein the multi-region lens has two lens surfaces, and at least one of the lens surfaces in at least one of the lens regions has an aspheric surface shape.

42. Multi-region lens according to claim 40, wherein the multi-region lens has at least one lens surface which has an aspheric shape in the first lens region and in the second lens region, the aspheric shape of the first lens region and the aspheric shape of the second lens region having a common spherical basis.

43. Multi-region lens according to claim 42, wherein the aspheric shape deviations from the common spherical basis are rotationally symmetrical with respect to a common axis.

44. Multi-region lens according to claim 40, wherein a zone not provided for imaging is situated between the first lens region and the second lens region, and is preferably non-transparent.

45. Optical lens arrangement, in particular for a projection objective, the lens arrangement with a disk-shaped transparent member and at least one truncated lens secured to the disk-shaped member.

46. Optical lens arrangement according to claim 45, wherein the transparent member is a lens or a plane-parallel plate.

47. Lens arrangement according to claim 45, wherein the transparent member has an annular edge, and a substantially annular mount is secured in the region of the annular edge.

48. Projection exposure apparatus for microlithography with an illuminating system and a catadioptric projection objective, wherein the projection objective is constituted according to one of claims 27-39.

49. Process for the production of semiconductor components and other finely-structured components, with the following steps:
preparation of a mask with a predetermined pattern;
illumination of the mask with ultraviolet light of a predetermined wavelength; and
projection of an image of the pattern onto a photosensitive substrate arranged in the region of the image plane of a projection objective, using a catadioptric projection objective according to one of claims 27-39.
